(19) United States
(12) Patent Application Publication
(10) Pub. No.: US 2004/0020993 A1
(43) Pub. Date: Feb. 5, 2004

(54) Method for luminescent identification and calibration

(76) Inventor: Larry R. Green, Tacoma, WA (US)

Correspondence Address: Blakely, Sokoloff, Taylor & Zafman, Seventh Floor, 12400 Wilshire Boulevard, Los Angeles, CA, 90025-1030, US

(21) Appl. No.: 10/035,367

(22) Filed: Dec. 28, 2001

(51) Int. Cl. G06K 19/06

(52) U.S. Cl. 235/491

(57) ABSTRACT

The present invention concerns methods of luminescent identification and calibration. In certain embodiments, items are simultaneously attached to a luminescent label, one or more luminescent calibration spots and one or more sample spots containing binding moieties. In preferred embodiments, the binding moieties are antibodies. In other preferred embodiments, target molecules that bind to the binding moieties are detected using the same luminescent tag as is found in the luminescent label and the calibration spots. In more preferred embodiments, the luminescent tag is Alexa Fluor 647. The label is of use to identify each array and the binding moieties found in each sample spot. The calibration spots are of use to more accurately quantify the amount of target compound attached to each sample spot. The methods provide for a more rapid preparation of labeled arrays of binding moieties, while minimizing the possibility of array contamination.

### BACKGROUND OF THE INVENTION

1. Field of the Invention

The present invention relates to the field of luminescent identification and calibration. More particularly, the present invention concerns methods related to luminescent labels and calibration spots.

2. Description of Related Art

Luminescent tags are of common use in detection technologies. Luminescent tags, available from commercial sources such as Molecular Probes, Inc. (Eugene, Oreg.), have been attached to various detector molecules, such as proteins, antibodies, antibody fragments, nucleic acids, oligonucleotide probes or primers, nucleotides, aptamers, substrates, analogs, inhibitors, activators, binding moieties, etc. Binding of a tagged molecule to a target compound may be detected by the presence of an appropriate luminescent signal. Alternatively, the target compound may be tagged and allowed to bind to a detector molecule.

In certain applications, detector molecules may be attached to a substrate in an array, for example with protein or nucleic acid chips that can detect the presence of a variety of different target compounds in a single sample. Such chips may, for example, simultaneously detect all gene products expressed in a particular cell line, tissue, organ or species. In some cases, the concentration of target compounds in a sample may be determined by measuring the amount of luminescence associated with an individual spot on an array. The accuracy of measuring target compound concentration may be increased by using calibration spots containing known amounts of the luminescent tag. The amount of luminescence detected from a sample spot, indicative of the concentration of target compound in the sample, may be compared to the amount of luminescence detected from one or more calibration spots.

Luminescent detectors may be designed for use with a variety of different arrays that are diagnostic for specific applications. For example, one array may screen for common bacterial pathogens. Another array may screen for parasitic organisms. A different array may screen for environmental contaminants or toxins. Each array may contain different detector molecules, each selective for a different target. Alternatively, multiple arrays may contain different detector molecules that bind to various parts of a single target compound or a related group of targets. Each type of array must be distinguishably labeled so that bound target compounds may be identified.

One method of labeling arrays and other objects involves applying an identifier, such as a bar code label. The technology of encoding information on various articles with bar codes is well known. Traditional bar code systems rely on the differences in reflection of the reading light from the black (light-absorbing) bars and the white (light-reflecting) spaces of the bar code. A typical bar code reader scans a laser beam across the bar code. Photodetectors monitor the reflectance from the bars and spaces, and the resultant electronic signals are processed and decoded.

A standard bar code strip may be applied to a chip, glass slide or other surface containing an array of detector molecules and used to identify the molecules on the array. However, application of bar code labels using ink printing or adhesive labels requires performing additional steps before or after the detector molecules are attached to the surface. The array may be contaminated during the additional handling by inks, chemicals or other compounds, resulting in decreased sensitivity or false positive or negative results obtained during sample testing.

A need exists for compositions and methods of labeling arrays and other objects with a luminescent label. Preferably the label, at least one calibration spot and any detector molecules bound to sample spots are attached to the array or object in a single step. More preferably, the label, any calibration spots and the luminescent tag to be used with the sample spots have similar or identical spectroscopic properties.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates an exemplary embodiment of an array containing multiple calibration and sample spots and a bar code label. The calibration spots and label contain the same luminescent tag.

### DESCRIPTION OF ILLUSTRATIVE EMBODIMENTS

Definitions

Terms that are not otherwise defined herein are used in accordance with their plain and ordinary meaning.

As used herein, “a” or “an” may mean one or more than one of an item.

As used herein, “luminescence” refers to the emission of light that does not derive energy from the temperature of the emitting body (i.e., emission of light other than incandescent light). “Luminescence” includes, but is not limited to, fluorescence, phosphorescence, thermoluminescence, chemiluminescence, electroluminescence and bioluminescence. “Luminescent” refers to an object that exhibits luminescence. In preferred embodiments, the light is in the visible spectrum. However, the present invention is not limited to visible light, but includes electromagnetic radiation of any frequency.

As used herein, “fluorescence” refers to the emission of light in response to exposure to radiation from an external source. “Fluorescent” refers to an object that exhibits fluorescence.

“Item” as used herein refers to an object to be labeled. The invention is not limiting as to the type of object to be labeled, so long as the object is capable of being marked with a luminescent label and calibration spot. Non-limiting examples of “items” include chips, arrays, glass slides, plastic slides, ceramic objects, silicon objects, metal objects and waveguides. The material of which the item is composed is not limiting. In preferred embodiments the item is transparent to the emitted light.

As used herein, the terms “analyte” and “target” mean any compound, molecule or aggregate of interest for detection. Non-limiting examples of targets include a protein, peptide, carbohydrate, polysaccharide, glycoprotein, lipid, hormone, growth factor, cytokine, receptor, antigen, allergen, antibody, substrate, metabolite, cofactor, inhibitor, drug, pharmaceutical, nutrient, toxin, poison, explosive, pesticide, chemical warfare agent, biowarfare agent, biohazardous agent, infectious agent, prion, radioisotope, vitamin, heterocyclic aromatic compound, carcinogen, mutagen, narcotic, amphetamine, barbiturate, hallucinogen, waste product, contaminant, heavy metal or any other molecule or atom, without limitation as to size. “Targets” are not limited to single molecules or atoms, but may also comprise complex aggregates, such as a virus, bacterium, Salmonella, Streptococcus, Legionella, E. coli, Giardia, Cryptosporidium, Rickettsia, spore, mold, yeast, algae, amoebae, dinoflagellate, unicellular organism, pathogen or cell. In certain embodiments, cells exhibiting a particular characteristic or disease state, such as a cancer cell, may be targets. Virtually any chemical or biological compound, molecule or aggregate could be a target. “Target compound” as used herein is synonymous with “target.”

As used herein, “detector molecule” and “binding moiety” refer to a molecule or aggregate that has binding affinity for one or more targets. Within the scope of the present invention virtually any molecule or aggregate that has a binding affinity for some target of interest may be a “binding moiety.” In preferred embodiments, the “binding moiety” is an antibody. In certain embodiments, the binding moiety is specific for binding to a single target, although in other embodiments the binding moiety may bind to multiple targets that exhibit similar structures or binding domains. With respect to antibody binding, it is anticipated that multiple targets may exhibit similar or identical antigenic epitopes, resulting in potential cross-reactivity of the binding moiety for related targets.

“Binding” refers to an interaction between a target and a binding moiety, resulting in a sufficiently stable complex so as to permit detection of the target:binding moiety complex. In certain embodiments, binding may also refer to an interaction between a second molecule and a target. For example, in a sandwich ELISA type of detection assay, the binding moiety is an antibody with affinity for a target. After binding of target to binding moiety, a second molecule, typically a tagged antibody with an affinity for a different epitope of the target, is added and the tertiary complex of first antibody:target:second tagged antibody is detected. In alternative embodiments, the first binding moiety may have affinity for a target while the second binding moiety has affinity for the first binding moiety. Although detection may involve the use of a second binding moiety with affinity for a target, in alternative embodiments the binary complex of binding moiety with target may be directly detected. The skilled artisan will be familiar with a variety of techniques by which a target:binding moiety complex may be detected, any of which may be utilized within the scope of the present invention.

The terms “detection” and “detecting” are used herein to refer to an assay or procedure that is indicative of the presence of one or more specific targets in a sample, or that predicts a disease state or a medical or environmental condition associated with the presence of one or more specific targets in a sample. It will be appreciated by those of skill in the art that all assays exhibit a certain level of false positives and false negatives. Even where a positive result in an assay is not invariably associated with the presence of a target, the result is of use as it indicates the need for more careful monitoring of an individual, a population, or an environmental site. An assay is diagnostic of a disease state or a medical or environmental condition when the assay results show a statistically significant association or correlation with the ultimate manifestation of the disease or condition.

Luminescent Tags

In preferred embodiments, target compounds or binding moieties may be attached to a luminescent tag. Attachment may be either covalent or non-covalent. Preferably, the same luminescent tag is incorporated into a label, such as a bar code label. The luminescent tag emits electromagnetic radiation, preferably visible light. The invention is not limiting as to the luminescent tag that is used, but may encompass any known luminescent tag. In certain preferred embodiments, the luminescent tag is fluorescent.

Luminescent tags may be obtained from commercial sources, such as Molecular Probes, Inc. (Eugene, Oreg.). Non-limiting examples of luminescent tags of use in the described methods include the fluorophores Alexa 350, Alexa 430, AMCA, BODIPY 630/650, BODIPY 650/665, BODIPY-FL, BODIPY-R6G, BODIPY-TMR, BODIPY-TRX, Cascade Blue, Cy2, Cy3, 4-(4′-dimethylaminophenylazo) benzoic acid (DABCYL), Cy5,6-FAM, 5-(2′-aminoethyl)aminonaphthalene-1-sulfonic acid (EDANS) Fluorescein, 5-carboxyfluorescein (FAM), HEX, 2′7′-dimethoxy-4′5′-dichloro-6-carboxyfluorescein (JOE), 6-JOE, Oregon Green 488, Oregon Green 500, Oregon Green 514, Pacific Blue, 6-carboxyrhodamine (R6G), REG, Rhodamine Green, Rhodamine Red, ROX, TAMRA, TET, Tetramethylrhodamine, and Texas Red.

In certain embodiments, it is contemplated that luminescently tagged beads, such as FluoSpheres (Molecular Probes, Eugene, Oreg.) may be used to luminescently tag targets. For example, a second antibody with affinity for the target may be covalently or non-covalently attached to a FluoSphere and used in a sandwich ELISA type assay. FluoSpheres have the advantage of providing a more intense luminescent tag, allowing detection of targets at increased sensitivity. It is contemplated that known quantities of FluoSpheres could also be used to create calibration spots on an array or other object. In certain embodiments, Alexa Fluor 647 is preferred as a luminescent tag. The fluorophore provides a brighter evanescent wave than other available fluorophores and is stable over a pH range from 4 to 10.

Other non-limiting examples of luminescent tags include 5-diphenyloxazole (PPO), anthracene, 2-(4′-tert-butylphenyl)-5-(4″-biphenyl)-1,3,4-oxadiazole (butyl-PBD); 1-phenyl-3-mesityl-2-pyrazoline (PMP), rare earth metal cryptate allopycocyanin (APC), allophycocyanin B, phycocyanin C or phycocyanin R, a rhodamine, thiomine, phycocyanin R, phycoerythrocyanin, phycoerythrin C, phycoerythrin B, phycoerythrin R, Eu trisbipyridine diamine (EuTBP) and Tb tribipyridine diamine (TbTBP).

Labels

As used herein, “label” refers to a mark or series of marks on an object that may be used to identify the object. In preferred embodiments, the label is a luminescent bar code label. However, the present invention is not limited to bar code labels, but may include any type of label that is capable of identifying an object. A non-limiting example of a label may include luminescent numerals and/or letters or some combination thereof. Another non-limiting example of a label may comprise a series of luminescent spots of differing intensity, such as calibration spots. The spatial arrangement and pattern of intensities of the luminescent spots may be interpreted as a binary or other code identifying a labeled object.

In certain preferred embodiments, the label may be in the form of a bar code. Any type of bar coding system known in the art may be used. For instance, each character in the bar code system known as Code 39 requires five bars and four spaces. Universal Product Codes (UPCs) are another common bar code used primarily in the retail grocery trade. The Codabar code was developed by Pitney Bowes and is used in retail price labeling systems and by Federal Express. Each character is represented by a stand-alone group of four bars and three interleaving spaces. “Bar codes” containing an array of marks of any desired size and shape that are arranged in a reference context or frame of one or more columns and one or more rows, together with a reference marker and a reference cue have also been developed [U.S. Pat. No. 5,128,528].

Labeled Items

Certain embodiments of the invention concern methods comprising attaching a luminescent label and at least one luminescent calibration spot to an item. A luminescent calibration spot may be of any size, shape or luminescent intensity. In some preferred embodiments, the luminescent label and calibration spots may be attached to a waveguide which may be used with a biosensor, as described in U.S. patent application Ser. No. 09/974,089 (filed Oct. 10, 2001), the entire text of which is incorporated herein by reference.

Waveguides

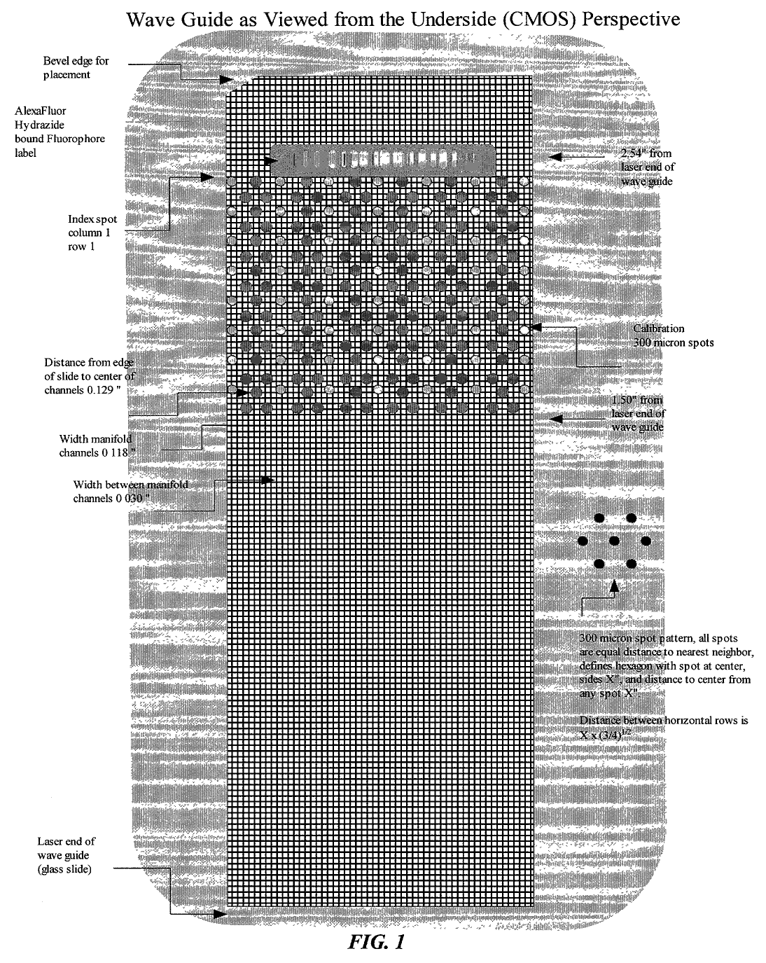

An exemplary embodiment of a labeled item with calibration and sample spots is shown in FIG. 1. The item is in the form of a glass slide that can act as a waveguide. In this illustrative embodiment, the binding moiety and calibration spots are 300 μm in diameter and the distance between spots is 0.074 inches. The illustrative embodiment shows a waveguide that may be used with a biosensor (U.S. patent application Ser. No. 09/974,089) containing, for example, six sample channels that may be used to simultaneously analyze six different samples. In this embodiment, calibration spots are located between or outside the sample channels, while a bar code label is located at one end of the waveguide. The sample spots, calibration spots and label may be simultaneously exposed to excitatory light from a diode laser, directed to one end of the waveguide. The waveguide transmits the excitatory light to each calibration spot, sample spot and the label.

Emitted light from the waveguide may be detected and analyzed by any known detector and analyzer. The detector may comprise a spectrometer, monochromator, CCD device, CCD camera, photomultiplier tube, photodiode, avalanche photodiode or any other device known in the art that can detect an optical signal. An optical signal may comprise any form of electromagnetic radiation, emission, or absorption, although in preferred embodiments the optical signal comprises visible light. Output from the detector may be analyzed and/or stored on any known analyzing device. Preferably, emitted light from the label, calibration spots and sample spots is detected and analyzed at the same time.

In preferred embodiments, the detector output is analyzed using a microprocessor or computer and the data is stored in a data storage unit, such as computer memory. In alternative embodiments, a data analysis and storage unit stores information on each sample collected, including the sample source, geographical location and any other data collected on the sample. The unit may further identify each analyte detected in the sample and store that data as well.

In the illustrative embodiment shown in FIG. 1, a series of binding moiety spots is arranged in a repeating diamond pattern along the length of each sample channel. The spot pattern may also be described as a hexagon with a spot in the middle, with each spot equidistant from its nearest neighbor. In this embodiment, the spots are 300 microns in diameter. All spots are an equal distance to the nearest neighbor, defining a hexagon with a spot at the center, sides of “X” inches long and a distance to the center from an spot as “X” inches. The distance between horizontal rows is “X” times the square root of 0.75. As shown, in this embodiment a total of 24 binding moiety spots are contained in each sample channel. In certain embodiments, each binding moiety spot may represent a different binding moiety. The binding moieties attached to each binding moiety spot may each be specific or selective for a different target. Alternatively, different amounts of the same binding moieties may be attached to different binding moiety spots. In another alternative, binding moieties that show different degrees of affinity or that bind to different epitopes on the same target may be attached to different binding moiety spots. As each binding moiety spot may be separately analyzed, a biosensor may be used to assay a single sample for multiple targets simultaneously. The skilled artisan will realize that the present invention is not limited to the embodiment shown in FIG. 1 and that either greater or lesser numbers of binding moiety spots, of different sizes, conformations and arrangements, may be used in the practice of the invention. In the exemplary embodiment shown in FIG. 1, up to 150 sample spots and 50 calibration spots could be attached to the waveguide surface.

In the representative embodiment illustrated in FIG. 1, the sample channels are 0.118 inches wide, with adjacent sample channels located 0.030 inches apart. The distance from the edge of the waveguide to the center of the first sample channel is 0.129 inches and the center to center distance between adjacent channels is 0.148 inches. This allows for calibration spots to be placed along the edges of the waveguide and in between adjacent sample channels. The calibration spots may contain known amounts of a luminescent tag, for example a fluorophore, to be detected. The amount of tag may be identical for each calibration spot or may vary in any desired way. In this way, the detector may be precisely calibrated along the length of each sample channel, allowing the accurate determination of the amount of target attached to each binding moiety spot. A unique index spot may be used to precisely position the calibration spots and binding moiety spots on the detector grid. The waveguide may contain a beveled edge to further facilitate precise positioning of the waveguide. In the exemplary embodiment, the bar code label is located 2.54 inches from the laser end of the waveguide and the proximal sample spots are located 1.5 inches from the laser end of the waveguide.

In certain embodiments, the waveguides may come with preloaded calibration spots and binding moiety spots. It is expected that a variety of such preloaded waveguides may be provided, for detection of different targets or for analysis of different types of samples. In such cases, it is preferred to identify each different type of waveguide, for example by use of a bar coding label. In some embodiments, the bar coding label could be read by the detector simultaneously with data collection. Although a custom waveguide is shown in FIG. 1, it is contemplated that alternative waveguides, such as commercially available light microscope slides, could be used in the practice of the invention. An exemplary waveguide is 1.0 inch wide and 3.0 inches long.

Cross-Linking Reagents

In certain embodiments, the binding moieties or targets of interest may be attached to a surface by covalent or non-covalent interaction. In other embodiments, luminescent tags may be attached to binding moieties or to targets of interest. One means for promoting such attachments involves the use of chemical or photo-activated cross-linking reagents. Such reagents are well known in the art and it is contemplated that any such reagent could be of use in the practice of the claimed invention.

Homobifunctional reagents that carry two identical functional groups are highly efficient in inducing cross-linking. Heterobifunctional reagents contain two different functional groups. By taking advantage of the differential reactivities of the two different functional groups, crosslinking can be controlled both selectively and sequentially. The bifunctional cross-linking reagents can be divided according to the specificity of their functional groups, e.g., amino, sulfhydryl, guanidino, indole, carboxyl specific groups. Of these, reagents directed to free amino groups have become especially popular because of their commercial availability, ease of synthesis and the mild reaction conditions under which they can be applied. A majority of heterobifunctional cross-linking reagents contains a primary amine-reactive group and a thiolreactive group.

Exemplary methods for cross-linking molecules are disclosed in U.S. Pat. No. 5,603,872 and U.S. Pat. No. 5,401,511, incorporated herein by reference. Various binding moieties can be covalently bound to surfaces through the cross-linking of amine residues. Amine residues may be introduced onto a surface through the use of aminosilane, for example. Coating with aminosilane provides an active functional residue, a primary amine, on the surface for crosslinking purposes. In another exemplary embodiment, the surface may be coated with streptavidin or avidin with the subsequent attachment of a biotinylated molecule, such as an antibody or target. In preferred embodiments, binding moieties are bound covalently to discrete sites on the surfaces. To form covalent conjugates of binding moieties and surfaces, various cross-linking reagents have been used, including glutaraldehyde (GAD), bifunctional oxirane (OXR), ethylene glycol diglycidyl ether (EGDE), and a water soluble carbodiimide, preferably 1-ethyl-3-(3-dimethylaminopropyl) carbodiimide (EDC).

In another non-limiting example, heterobifunctional cross-linking reagents and methods of using the cross-linking reagents are disclosed in U.S. patent Ser. No. 5,889,155. The crosslinking reagents combine, for example, a nucleophilic hydrazide residue with an electrophilic maleimide residue, allowing coupling in one example, of aldehydes to free thiols. The crosslinking reagent used can be designed to cross-link various functional groups.

### EXAMPLES

### Example 1

### Method For Luminescent Calibration and Labeling

In an exemplary embodiment, the methods and compositions disclosed herein may be used to prepare waveguides (slides) for detection of various pathogens, contaminants, toxins or other target compounds. In a preferred embodiment, detection may occur using a sandwich ELISA type of assay. In this method, a first binding moiety (preferably an antibody) is attached to the waveguide surface. The first antibody is exposed to a sample containing a target compound. After the target binds, the waveguide is exposed to a second binding moiety, preferably an antibody with affinity for a different epitope of the target. In preferred embodiments, the second antibody is biotinylated. The presence of first antibody:target:second antibody complexes on the waveguide surface is detected by addition of streptavidin attached to a luminescent tag, such as Alexa Fluor 647 (Molecular Probes, Eugene, Oreg.). Alternatively, the second antibody could be attached to an enzyme that catalyzes a reaction producing a luminescent product. Such enzyme coupled antibodies are well known in the art.

Standard Method for Preparing Slide Arrays

Although there are a variety of methods used in preparing slides, the most common steps involve “spotting” of material on a glass surface. Slides may be printed with various materials. The printing of material can involve ink-jet type deposition (piezo-electric spotting), or stamping. These are the most common methods, but other methods such as direct contact pin printing, etc. are also used. The process is semi-automated, but still slow. The procedures typically involved are as listed below.

1. Suspending material for deposition in an appropriate solution. Separate wells are used for each antibody or calibration tag to be used, and the material is deposited in an array by taking material from the appropriate well as required for spotting on the glass slide.

2. Preparing clean glass slides to receive material—with an appropriate binding agent to contain the spots on the slide. Examples are Superaldehyde or superamine (Telechem Intl., Inc., Sunnyvale, Calif.) coated slides to bind either amino or carboxyl groups to the surface.

3. Applying the material to the slide in a clean and protected environment. Software programs are used to accurately place spots on the slide in the selected array pattern.

4. Neutralizing the Superaldehyde, superamine, or other binding agent used on the coated slides so that tests can be done on the spots.

5. Inspecting slides.

6. Attaching an identifying label (barcode) to each slide. This is done by hand with gum labels, or printed with a printer on the surface of the slide.

New Method for Minimizing contamination and Increasing Production Efficiency:

In this exemplary embodiment, a computer program was used to determine the array pattern (FIG. 1). A fluorescent tag (Alexa Fluor hydrazide) was used for the calibration spots, which were deposited in a predetermined pattern with known amounts of fluorophore. Antibodies or other binding moieties may be applied to sample spots as well. A luminescent bar code or other “batch” label may be deposited on the slide using the same fluorophore tag at the same time as calibration spot deposition and antibody spotting on the array. Very little material is required, resulting in no significant cost associated with the luminescent label. This procedure completely eliminates the separate attachment of a label and avoids potential handling and or contamination of slides that can occur while affixing labels to the glass slide. By eliminating that procedure, the speed of production nearly doubles. Simultaneously affixing the label, calibration spots and binding moiety spots also assures that the proper label is attached for each batch of slides, eliminating the possibility that the wrong label could be applied to a slide after they are spotted. After neutralizing the binding agent, slides are ready for packaging with no further handling.

When labeled slides are used with a portable biosensor (e.g., U.S. patent application Ser. No. 09/974,089), a detector can read the label off the waveguide and perform a software encoded validation check to determine if the correct array is being used for the proposed test in process. The label fluorescence can also be used as a control for the deposition of calibration spots to ensure that no errors occurred in the manufacturing process.

A non-limiting example of a method of attaching luminescent labels and calibration spots is disclosed below. The skilled artisan will realize that the invention is not limited to the specific procedure disclosed, but may include additional or modified procedures as well.

1. A solution comprising the luminescent tag is prepared and placed in an appropriate well or wells of 96 well or 384 well plates. An exemplary luminescent tag to be used for the calibration spots and label is the fluorophore Alexa Fluor 647 Hydrazide (Molecular Probes, Eugene, Oreg.). For calibration spots, the fluorophore may be deposited in 300 micron spots as shown in FIG. 1. The luminescent label may be deposited at the distal end of the waveguide from the laser excitation light. In preferred embodiments, the label is in the form of a barcode for quality control batch identification. In some embodiments, every slide produced on a particular day with a defined antibody array has the same barcode. A slide produced on a different day or with a different antibody array will have a different label. In other embodiments, each batch of slides produced may have a different label. Binding moieties are suspended at appropriate concentrations and placed into 96 well or 384 well plates.

2. The entire surface of a slide is coated with Superaldehyde (Telechem Intl., Inc., Sunnyvale, Calif.). This binding group can bind to amino groups from the antibody and can condense with the hydrazide portion of the luminescent tag to affix calibration spots and/or a label to the glass surface.

3. The temperature and humidity of the arrayer (Cartesian Technologies arrayer PixSys 5500, Irvine, Calif.) environment are checked and adjusted before a print run is started. Preferably the printing environment is 68-71° F. with 50-58% relative humidity. An appropriate arraying program is run on a Cartesian Technologies arrayer (PixSys 5500) to print samples on the substrates. The program determines the location and identity of each binding moiety to be applied to the slide. The program also determines the label, such as a barcode label, and the location and amount of fluorophore applied to each calibration spot. Appropriate binding moieties and luminescent tag solution are placed on the arrayer platen in a predetermined pattern.

4. The binding moieties and luminescent tag solution are transferred from the platen to the slide and allowed to react with the Superaldyhyde.

5. Unreacted Superaldyhyde groups are neutralized with a non-immunogenic amine, such as lysine.

Preferably, quality control checks are performed at various stages of the slide printing procedure. Appropriate numbers of slides may be quality control checked at the beginning, middle, and end of a printing run to verify that proper printing occurred. A visual inspection of spots and barcode under may be performed under a microscope. Quality control checks for cross-linking may be performed on a statistically appropriate number of arrays for each batch to ensure proper attachment of binding moiety to the substrate. In a non-limiting example, crosslinking of antibody arrays may be checked by incubation with Cy3 labeled Goat anti Mouse secondary antibody, then scanning of the arrays to visualize the spots. This ensures that the antibodies have indeed attached to the substrate. A third post printing quality control check of the arrays may be performed to be ensure that the antibodies bound to the substrates are functional. For example, an appropriate target complex may be added to a sample of slides and then incubated with a labeled secondary antibody to ensure that the primary antibodies are reactive with the appropriate targets.

The methods disclosed herein provide efficient production of diagnostic slides at low cost with minimum handling. The methods provide for increased sensitivity and specificity, decreased cost and reduced contamination compared to alternative methods of identification and calibration.

All of the COMPOSITIONS, METHODS and APPARATUS disclosed and claimed herein can be made and executed without undue experimentation in light of the present disclosure. While the compositions and methods of this invention have been described in terms of preferred embodiments, it will be apparent to those of skill in the art that variations may be applied to the COMPOSITIONS, METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.

U.S. Pat. No. 5,128,528

U.S. Pat. No. 5,401,511

U.S. Pat. No. 5,603,872

U.S. Pat. No. 5,889,155

U.S. patent application Ser. No. 09/974,089

What is claimed is:

1. A method comprising:
a) attaching a luminescent label to an item; and
b) attaching at least one luminescent calibration spot to the item.

2. The method of claim 1, wherein the label and the at least one calibration spot contain the same luminescent tag.

3. The method of claim 1, wherein the luminescent tag is fluorescent, phosphorescent, chemiluminescent, thermoluminescent or electroluminescent.

4. The method of claim 4, wherein the fluorescent tag is Alexa Fluor 647.

5. The method of claim 1, wherein the label is a bar code.

6. The method of claim 1, further comprising attaching one or more detector molecules to at least one sample spot on the item.

7. The method of claim 6, wherein different sample spots contain different detector molecules.

8. The method of claim 6, wherein the detector molecules are antibodies.

9. The method of claim 6, further comprising exposing the one or more detector molecules to a sample suspected of containing one or more target compounds.

10. The method of claim 1, further comprising attaching one or more target compounds to at least one sample spot on the item.

11. The method of claim 10, further comprising exposing the one or more target compounds to at least one detector molecule.

12. The method of claim 9 or claim 11, further comprising detecting the presence of at least one detector molecule:target compound complex.

13. The method of claim 12, wherein the at least one complex is tagged with the same luminescent tag as the label and the at least one calibration spot.

14. The method of claim 12, further comprising measuring the amount of light emitted from each calibration spot and each sample spot on the item.

15. The method of claim 14, further comprising determining the concentration of each target compound in the sample by comparing the light emitted from the sample spots and the calibration spots.

16. The method of claim 12, further comprising reading the label and identifying the item.

17. The method of claim 6, wherein the label, calibration spots and sample spots are attached to the item using an aldehyde cross-linking group.

18. The method of claim 17, wherein the substrates for the label, calibration spots and samples spots are placed on a platen before transfer to the item.

19. The method of claim 18, wherein the placement of substrates on the platen is controlled by a computer program.

20. An item prepared by the method of claim 1.

21. The item of claim 20, wherein the item is a glass slide.

22. The item of claim 21, wherein the item is a waveguide.
